(19) United States
(12) Patent Application Publication
(10) Pub. No.: US 2024/0306611 A1
(43) Pub. Date: Sep. 19, 2024

(54) BIRD FEEDER HANGER ASSEMBLY

(71) Applicant: CLASSIC BRANDS, LLC, Denver, CO (US)

(72) Inventors: Robert W. Donegan, Denver, CO (US); Bryan Krueger, Denver, CO (US); John Bruno, Parker, CO (US)

(73) Assignee: CLASSIC BRANDS, LLC, Denver, CO (US)

(21) Appl. No.: 18/676,972

(22) Filed: May 29, 2024

Related U.S. Application Data
(62) Division of application No. 14/531,925, filed on Nov. 3, 2014, now abandoned.
Application No. 14/531,925 is a continuation-in-part of application No. 29/480,509, filed on Jan. 27, 2014, now Pat. No. D729989.
(60) Provisional application No. 61/899,044, filed on Nov. 1, 2013.

(51) Int. Cl. A01K 39/012; A01K 39/01; A01K 39/02; A01K 39/04; F16M 13/02

(52) U.S. Cl. CPC A01K 39/012; A01K 39/0113; A01K 39/0206; A01K 39/04; F16M 13/02

(57) ABSTRACT

Implementations described and claimed herein provide apparatuses and methods for facilitating filling and cleaning of bird feeders that are aesthetically pleasing and adaptable for attracting different types of birds. In one implementation, a bird feeder includes a proximal edge extending around a central line and defining a plane. An outer surface and an inner surface each extends distally from the plane. The inner surface is connected to the outer surface by the proximal edge. An opening is formed by the proximal edge and positioned on the plane. A hanger is disposed distal to and not intersecting the plane, and the hanger assembly has a hanging portion positioned on the central line.

### CROSS-REFERENCE TO RELATED APPLICATIONS

The present application is a division of and claims priority under 35 U.S.C. § 120 to U.S. patent application Ser. No. 14/531,925, entitled “Bird Feeder Hanger Assembly” and filed Nov. 3, 2014, which is a continuation-in part of and claims priority under 35 U.S.C. § 120 to U.S. Design patent application Ser. No. 29/480,509 (now U.S. Design Pat. No. D729,989), entitled “Ant Moat for a Bird Feeder” and filed Jan. 27, 2014, and claims benefit of priority under 35 U.S.C. § 119 to U.S. Provisional Patent Application No. 61/899,044, entitled “Bottle and Hanger for a Wild Bird Feeder” and filed on Nov. 1, 2013. Each of these applications is incorporated by reference in its entirety herein.

### BACKGROUND

Many bird feeders are notoriously difficult to clean and fill. For example, bird feeders configured to dispense nectar generally must be inverted to receive the nectar. Such bird feeders commonly include a bottle with an opening at one end that is configured to engage a base through which the nectar is dispensed and a hanger positioned at the opposite end of the bottle to hang the bird feeder. To fill the bird feeder, a user holds the bottle in the inverted position with one hand while attempting to pour the nectar into the opening of the bottle with the other hand. The user then endeavors to secure the base to the end of the bottle with the opening while holding the bottle in this inverted position. Often, such bird feeders have tops and/or hangers that are shaped such that the user is unable to utilize a flat surface to stabilize the bird feeder during this process, thereby increasing the incidence of spillage and further exacerbating these challenges. Further, bird feeders attempting to address these challenges often sacrifice appearance and quality of design, which is an important feature to users.

It is with these observations in mind, among others, that various aspects of the present disclosure were conceived and developed.

### BRIEF SUMMARY

Implementations described and claimed herein address the foregoing problems by providing apparatuses and methods for facilitating filling and cleaning of bird feeders that are aesthetically pleasing and adaptable for attracting different types of birds. In one implementation, a bird feeder includes a proximal edge extending around a central line and defining a plane. An outer surface and an inner surface each extends distally from the plane. The inner surface is connected to the outer surface by the proximal edge. An opening is formed by the proximal edge and positioned on the plane. A hanger is disposed distal to and not intersecting the plane, and the hanger assembly has a hanging portion positioned on the central line.

In another implementation, a bird feeder includes a reservoir configured to hold bird nectar. The reservoir has a mouth disposed opposite a planar surface, and the mouth is configured to dispense the nectar from the reservoir into a basin assembly. A hanger assembly has a reservoir engaging portion configured to engage a connecting portion of the reservoir near the planar surface, such that a first connector engaged to a second connector are disposed distal to the planar surface. The hanger is configured to pivot to a folded position with the hanger not protruding past the planar surface.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates a perspective view of an example nectar bird feeder that facilitates filling and reduces spillage.

FIG. 2 shows an exploded view of a hanger assembly and bottle of the nectar bird feeder of FIG. 1.

FIG. 3 shows a detailed view of the hanger assembly and the bottle of the nectar bird feeder of FIG. 2 assembled.

FIG. 4 displays the nectar bird feeder of FIG. 1 positioned to receive nectar.

FIG. 5 illustrates a perspective view of another example nectar bird feeder that facilitates filling and reduces spillage.

FIG. 6 shows an exploded view of a hanger assembly and bottle of the nectar bird feeder of FIG. 5.

FIG. 7 shows a detailed assembled view of the hanger assembly and the bottle of the nectar bird feeder of FIG. 6.

FIG. 8 displays the nectar bird feeder of FIG. 5 positioned to receive nectar.

FIG. 9 illustrates an example basin assembly for a nectar bird feeder.

FIG. 10 illustrates a perspective view of another example nectar bird feeder that facilitates filling and reduces spillage with the hanger assembly not shown.

FIGS. 11A, 11B, and 12 show top perspective, bottom perspective, and side views, respectively, of a hanger assembly having an ant moat and with the hanger removed for clarity.

FIGS. 13 and 14 show side and isometric views of the nectar bird feeder of FIG. 10 with the hanger assembly of FIGS. 11A-12 positioned to receive nectar.

FIGS. 15A and 15B show isometric views of the hanger assembly of FIGS. 11A to 12 with a hanger that hooks onto pegs in an upright and a folded position, respectively.

FIGS. 16A and 16B show isometric views of the hanger assembly of FIGS. 11A to 12 with a hanger that hooks inwardly through holes in an upright and a folded position, respectively.

FIGS. 17A and 17B show isometric views of the hanger assembly of FIGS. 11A to 12 with a hanger that hooks outwardly through holes in an upright and a folded position, respectively.

FIGS. 18A and 18B show isometric views of the hanger assembly of FIGS. 11A to 12 with a hanger that hooks into slots in an upright and a folded position, respectively.

FIGS. 19A and 19B show isometric views of the hanger assembly of FIGS. 11A to 12 with another hanger that hooks into slots in an upright and a folded position, respectively.

FIGS. 20A and 20B show isometric views of the hanger assembly of FIGS. 11A to 12 with another hanger that hooks into slots in an upright and a folded position, respectively.

FIGS. 21A and 21B show isometric views of the hanger assembly of FIGS. 11A to 12 with a hanger having chains that hook through holes in an upright and a folded position, respectively.

FIGS. 22A and 22B show isometric views of the hanger assembly of FIGS. 11A to 12 with a hanger that hooks inwardly through holes in an upright and a folded position, respectively.

FIGS. 23A and 23B show isometric views of the hanger assembly of FIGS. 11A to 12 with a hanger that slides vertically through slots in an upright and a folded position, respectively.

FIGS. 24A and 24B show top perspective and bottom perspective views, respectively, of a hanger assembly having a cap.

### DETAILED DESCRIPTION

Aspects of the present disclosure involve apparatuses and methods for facilitating filling and cleaning of bird feeders that are aesthetically pleasing and adaptable for attracting different types of birds. In one aspect, a bird feeder adapted to hold and dispense nectar is provided. The nectar bird feeder includes a bottle, a hanger assembly, and a basin assembly. To facilitate filling and cleaning, the bottle includes a wide mouth opening at a first end of the bottle and a substantially planar surface at an opposite end of the bottle. The hanger assembly is configured to engage the bottle at the end of the bottle having the planar surface, such that the nectar bird feeder is invertable for filing or cleaning by placing either the planar surface of the bottle or a portion of the hanger assembly on a surface, such as a table, to stabilize the bottle. The hanger of the hanger assembly is configured to move such that it does not obstruct the placement of the inverted bird feeder on the surface (e.g., a table). The nectar bird feeder may include various features that may be adapted to attract various nectar feeding birds, for example: hummingbirds, orioles, or the like.

In some aspects, the nectar bird feeder has a decorative, antique appearance with a glass bottle and metal accent finishing to provide an attractive, upscale appearance that is appealing to users. The bottles may be a variety of colors with different engravings or other decorative features. For example, the bird feeders may have features similar to those shown in U.S. Design patent application Ser. No. 29/438,289, entitled “Bottle for a Wild Bird Feeder” and filed on Nov. 28, 2012, which is incorporated herein in its entirety.

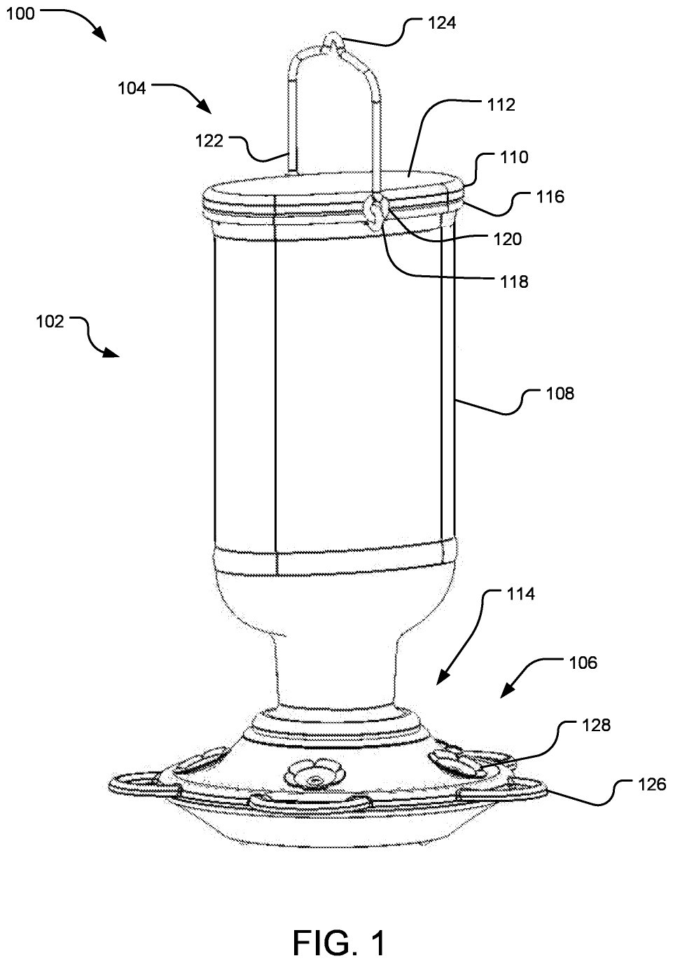

As can be understood from FIG. 1, which shows a perspective view of an example nectar bird feeder 100, a reservoir 102 is configured to hold bird food, which may nectar or the like. The nectar bird feeder 100 further includes a hanger assembly 104 and a basin assembly 106.

In one implementation, the reservoir 102 is a bottle that may be made from a variety of materials, including but not limited to glass, metal, ceramics, plastics, or the like, and include one or more decorative features. To increase aesthetic appeal, the reservoir 102 may be made from glass that includes different decorative features, such as color, engraving, or other designs.

In one implementation, the reservoir 102 includes an elongated portion 108, a connecting portion 110, a substantially planar surface 112, and a mouth 114 that may be tapered to accept nectar with minimum spillage. The reservoir 102 may be a variety of shapes and sizes. For example, the elongated portion 108 may be longer along a longitudinal length of the reservoir 102 between the planar surface 112 and the mouth 114 relative a width and depth of the elongated portion 108. Further, the width of the elongated portion 108 may be longer relative to the depth of the elongated portion 108. These example features of the elongated portion 108, together with features of the mouth 114 and the planar surface 112, may create an overall flask-shaped appearance of the reservoir 102. However, other shapes are contemplated, including, without limitation, generally cylindrical, conical, cubical, contoured, angular, or the like. Further, the reservoir 102 may be adapted to hold various capacities of nectar. For example, the reservoir 102 may be adapted to hold approximately 10-25 oz. of nectar. However, other sizes are contemplated that maximize the capacity of nectar without sacrificing the ability to hang the nectar bird feeder 100 in various locations.

In one implementation, the hanger assembly 104 includes a reservoir engaging portion 116 and a hanger 122. The hanger assembly 104 may be made from a variety of materials, including but not limited to metal, glass, ceramics, plastics, or the like, and include one or more decorative features. To increase aesthetic appeal, the hanger assembly 104 may be made from a metal having decorative features, such as color (e.g., pewter), engravings, designs, or the like.

The reservoir engaging portion 116 may be sized and shaped to mirror the size and shape of the reservoir 102, and the hanger 122 may be sized and shaped to adequately hold the nectar bird feeder 100 when suspended. In one implementation, the reservoir engaging portion 116 has a first connector 118 adapted to receive a second connector 120 of the hanger 122. The connectors 118 and 120 may be any engaging feature (e.g, hooks, slots, pegs, cars, and/or the like) that permits the reservoir engaging portion 116 to attach to the hanger 122 in a manner that allows the hanger 122 to pivot, slide, or otherwise move relative to the reservoir engaging portion 116. In one implementation, the hanger 122 includes a hanging portion 124 that permits the hanger 122 to securely attach to an item, such as a tree limb, hook, or the like.

The basin assembly 106 is adapted to permit one or more birds to access the nectar. The basin assembly 106 may be made from a variety of materials, including but not limited to metal, glass, ceramics, plastics, or the like, and include one or more decorative features. To increase aesthetic appeal, the basin assembly 106 may be made from a metal having decorative features, such as color (e.g., pewter), engravings, designs, or the like. In one implementation, the basin assembly 106 includes one or more perches 126, made from a durable integral metal or similar material, corresponding to one or more ports 128 through which a bird may access the nectar. The ports 128 may be removable or replaceable to attract different birds. For example, the ports 128 may be shaped like a flower to attract birds, such as hummingbirds, orioles, or the like, and may include an opening sized to accommodate the beak of the desired bird and prevent insects, such as bees, or animals from accessing the nectar. Orioles have bigger beaks than hummingbirds, so the opening may be larger to accommodate the oriole beak when attracting orioles. Similarly, the number of perches 126 and corresponding ports 128 included in the basin assembly 106 may vary depending on the type of bird attracted. For example, because orioles are larger birds, there may be fewer perches 126 and ports 128 included when attracting orioles than when attracting hummingbirds.

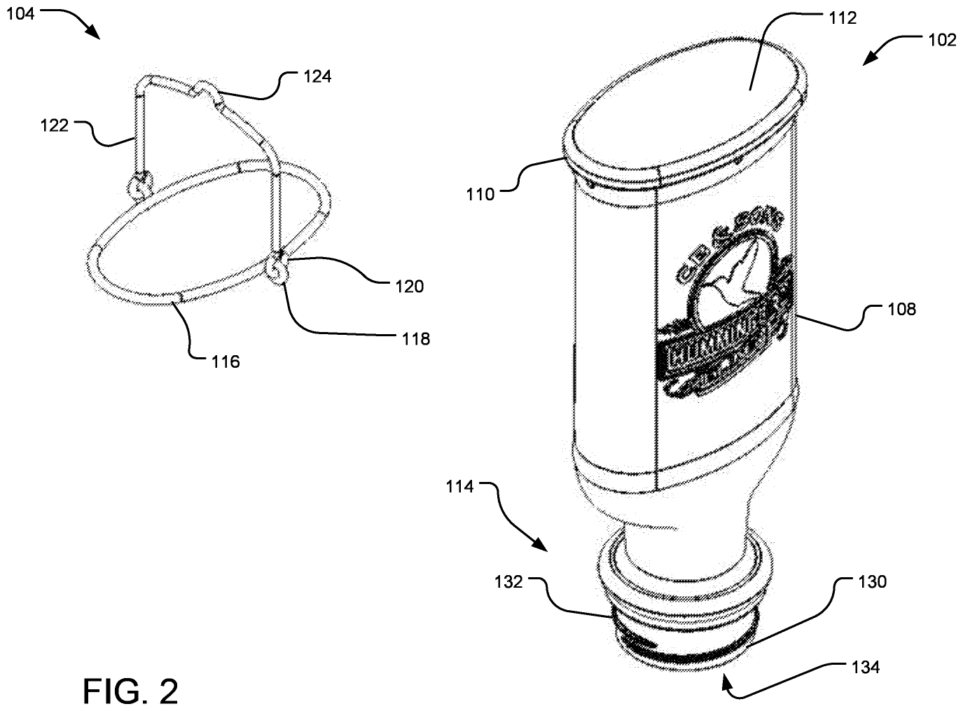

As can be understood from FIG. 2, the reservoir 102 may include various features near the mouth 114 to engage the basin assembly 106 and to facilitate filling. In one implementation, the mouth 114 tapers from the elongated portion 108 to a lip, which protrudes from the mouth 114 to secure components of the basin assembly 106 when engaged. The mouth 114 further includes a surface 130 having engagers 132, such as helical threads, to engage the basin assembly 106 to close or occlude the reservoir 102. The mouth 114 includes a relatively wide opening 134 to accept nectar during filling with minimum spillage and to dispense the nectar into the basin assembly 106 when engaged.

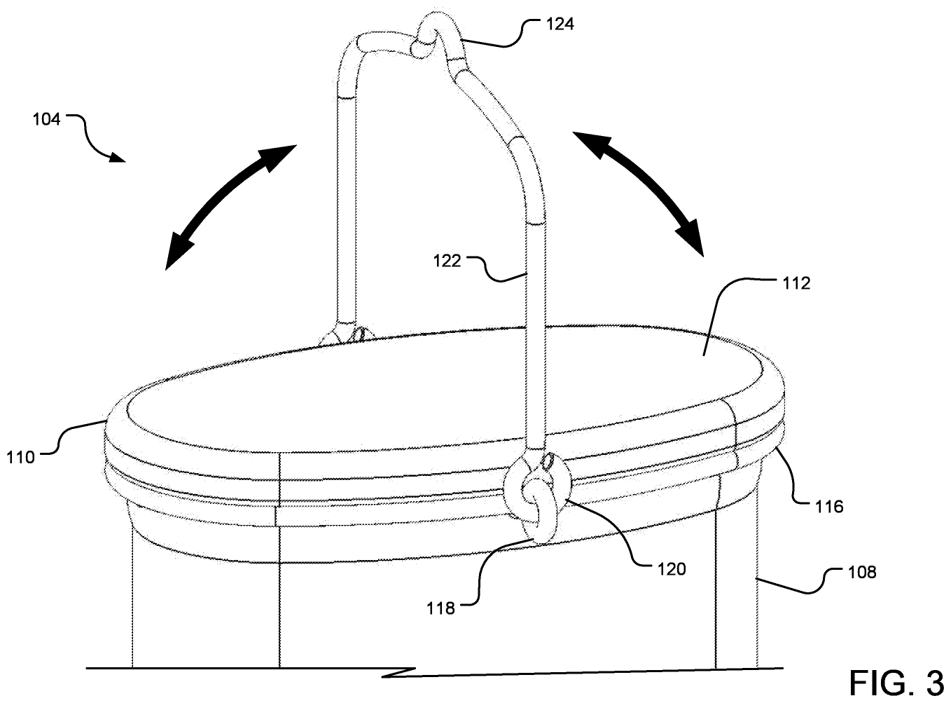

To engage the hanger assembly 104, the mouth 114 may be inserted or threaded through an opening formed by the reservoir engaging portion 116 and the hanger 122 when placed in a folded position. The hanger assembly 104 is then slid longitudinally along the length of the elongated portion 108 until the reservoir engaging portion 116 engages the connecting portion 110 of the reservoir 102, as shown in FIG. 3. The connecting portion 110 may be, without limitation, a lip, a protrusion, a surface with engagers (e.g., helical threads), a surface configured for a snap fit, and/or other features configured to engage the hanger assembly.

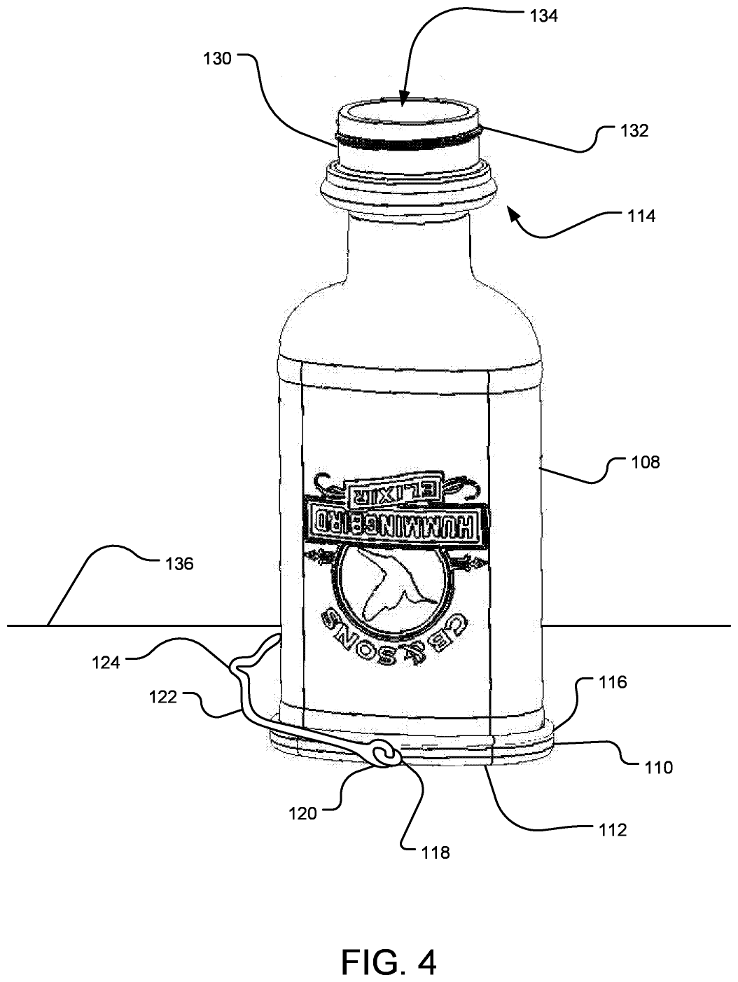

In one implementation, the reservoir engaging portion 116 engages the connecting portion 110 along the elongated portion 108 such that the reservoir engaging portion 116 does not protrude past the planar surface 112 of the reservoir 102. The hanger 122 may then be pivoted or otherwise moved into an upright position (e.g., shown in FIG. 2) for hanging or into a folded position (e.g., shown in FIG. 4) for removal, filling, or cleaning.

Turning to FIG. 3, arrows show the directions that the hanger 122 may pivot relative to the reservoir engaging portion 116 and the planar surface 112 of the reservoir 102, in one implementation. For example, as can be understood from FIG. 4, the hanger 122 may be pivoted into a folded position to provide unobstructed placement of the planar surface 112 of the reservoir 102 on a surface 136, such as a table. In this example, because the reservoir engaging portion 116 does not protrude past the planar surface 112 and the hanger 122 may fold such that the hanger 122 does not protrude past the planar surface 112, the reservoir 102 may be stably placed on the surface 136 during filling or cleaning.

As can be understood from FIG. 4, in one implementation, to fill the nectar bird feeder 100 to feed one or more birds, the nectar bird feeder 100 is inverted and the basin assembly 106 is removed. Inverting the nectar bird feeder 100 before removing the basin assembly 106 reduces spillage of any nectar held in the reservoir 102 and/or the basin assembly 106. The hanger 122 is pivoted into the folded position, and the planar surface 112 of the reservoir is placed on the surface 136. Nectar is then poured into the reservoir 102 through the opening 134, which is sized to accept the nectar with minimum spillage. Still in the inverted position, the basin assembly 106 is secured onto the mouth 114. The nectar bird feeder 100 may be flipped over and the hanger 122 pivoted into the upright position for hanging. In this position, gravity forces the nectar to dispense from the reservoir 102 into the basin assembly 106 for access by one or more birds.

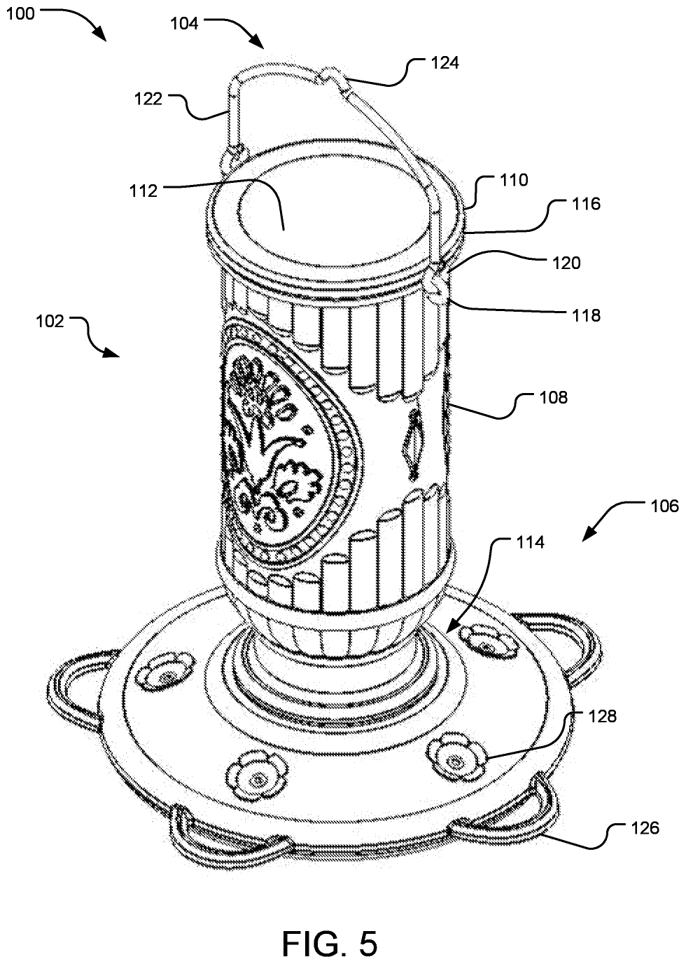

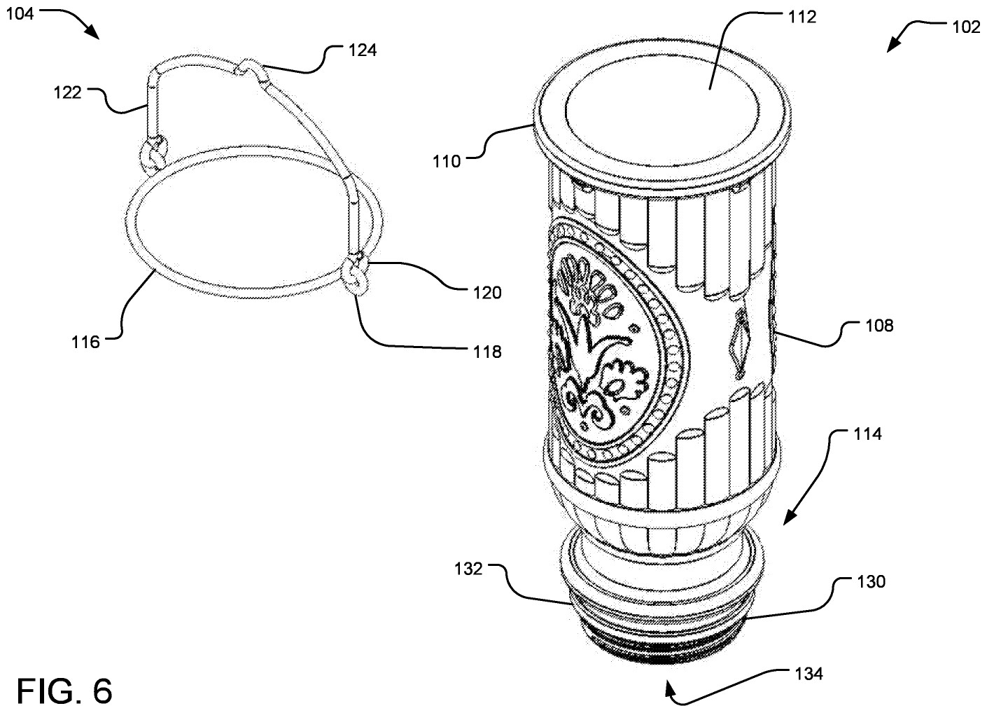

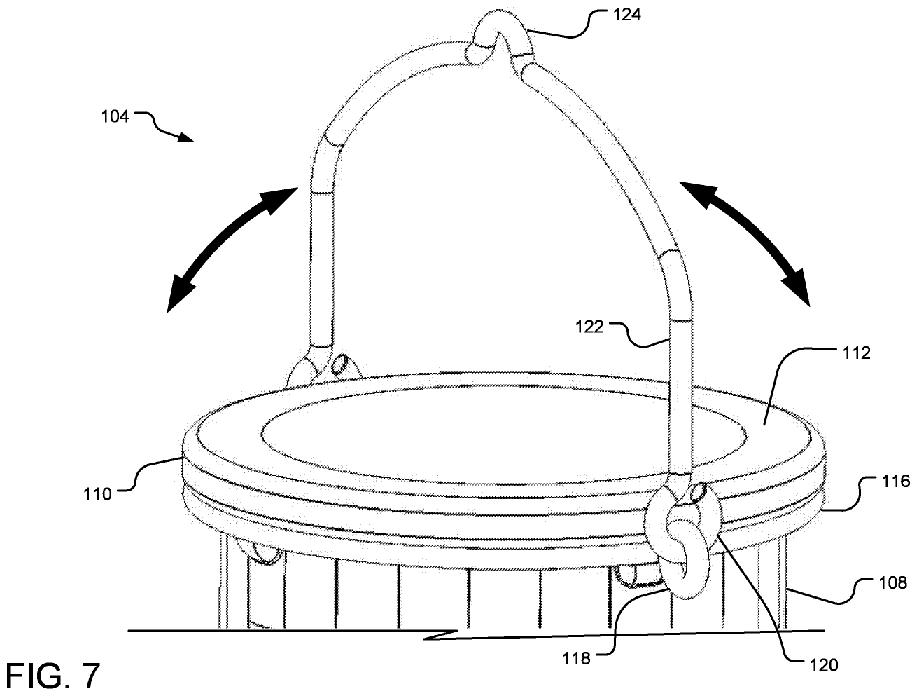

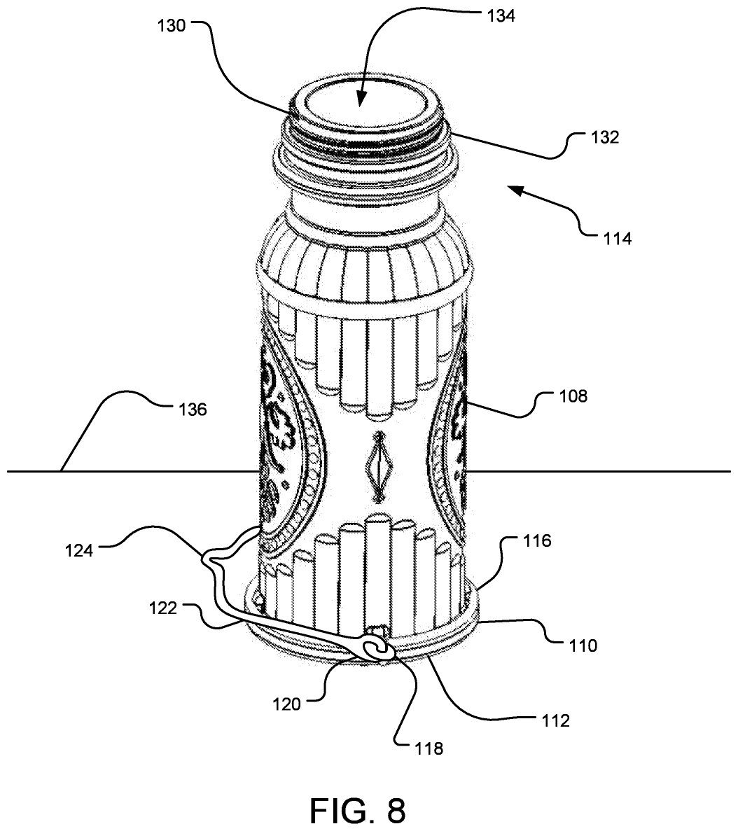

FIGS. 5-8 illustrate another implementation of the nectar bird feeder 100. As shown in FIGS. 5-8, the reservoir 102 may have a generally cylindrical shape with various decorative features, and the reservoir engaging portion 116 may be similarly shaped to engage the reservoir 102 along the elongated portion 108 near the connecting portion 110. The other features of the nectar bird feeder 100 shown in FIGS. 5-8 may be substantially the same as those described with respect to FIGS. 1-4.

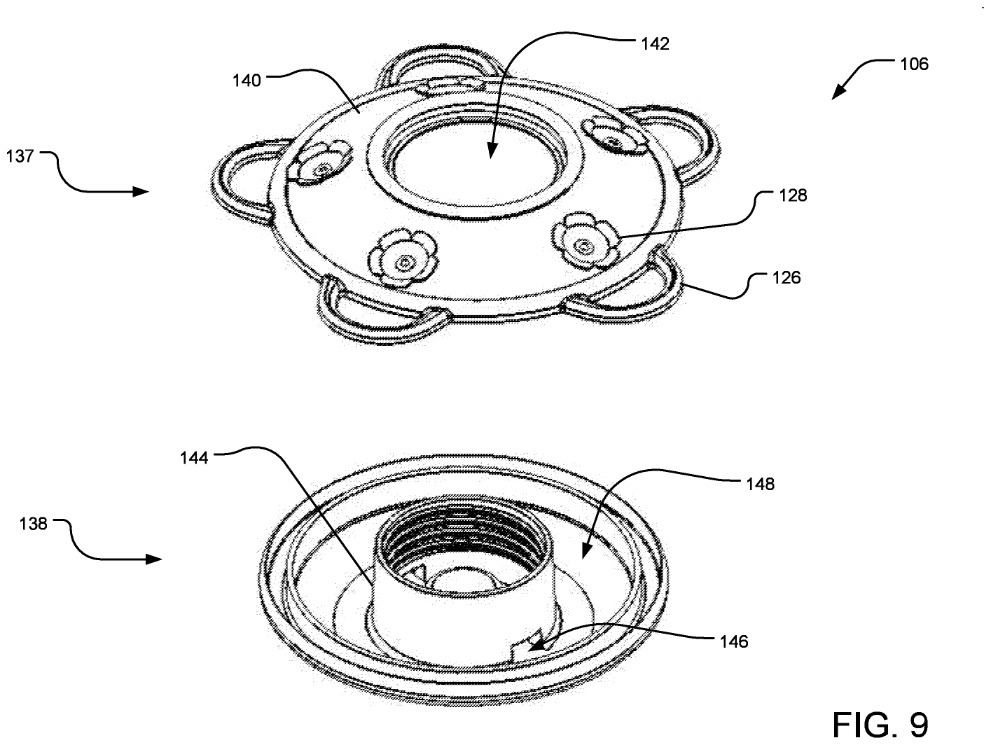

FIG. 9 shows an exploded view of the basin assembly 106. In one implementation, the basin assembly 106 includes a top portion 137 and a bottom portion 138. The top portion 137 includes a cover 140 for presenting the one or more ports 128 and from which the one or more perches 126 protrude. The top portion 137 covers the bottom portion 138 to prevent insects, such as bees, and animals from accessing the nectar and reduces loss of the nectar to evaporation. In one implementation, the top portion 137 includes an opening 142 in the cover 140 through which the mouth 114 of the reservoir 102 may be inserted to engage the bottom portion 138 to close or occult the reservoir 102 and dispense the nectar.

In one implementation, the bottom portion 138 includes an engaging member 144 for engaging the mouth 114. Stated differently, the engaging member 144 may include features to receive and engage the engagers 132, such as helical threads, of the surface 130 of the mouth 114 to close or occlude the reservoir 102. The engaging member 144 may include one or more openings 146 to controllably dispense nectar from the reservoir 102 into a basin 148. The nectar is dispensed using gravity to fill the basin 148 such that one or more birds may access the nectar held in the basin 148 through the one or more ports 128.

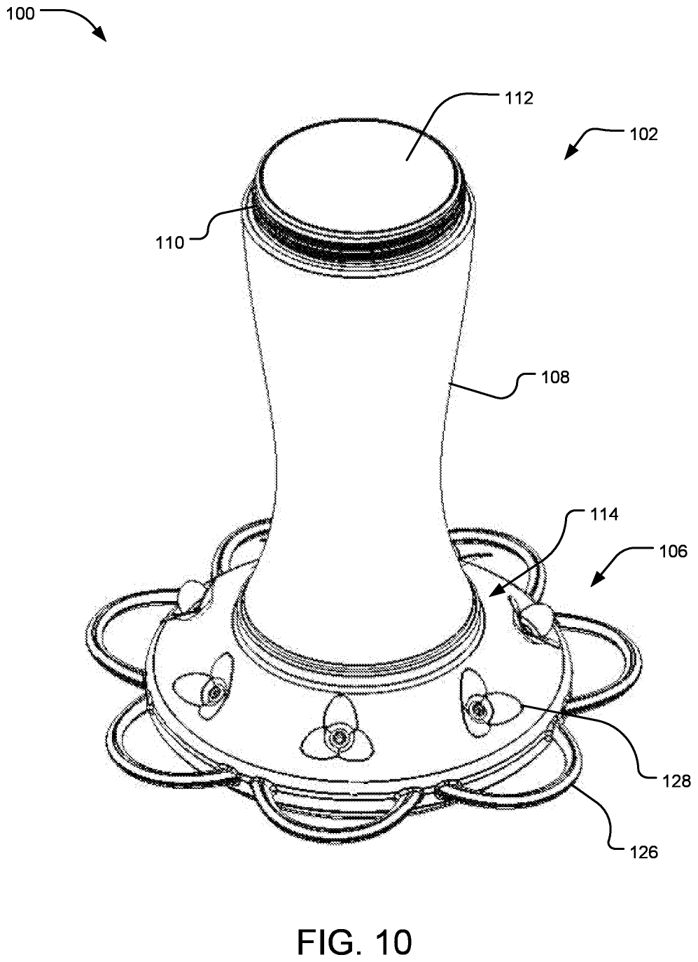

FIGS. 10-14 illustrate another implementation of the nectar bird feeder 100 with the hanger assembly 104 not shown. As shown in FIGS. 10-14, the reservoir 102 may have an elongated, contoured shape, and the reservoir engaging portion 116 (not shown) may be sized and shaped to engage the reservoir 102 at the connecting portion 110, which includes engagers, such as helical threads. Some of the other features of the nectar bird feeder 100 shown in FIGS. 10-14 may be substantially the same as those described with respect to FIGS. 1-9.

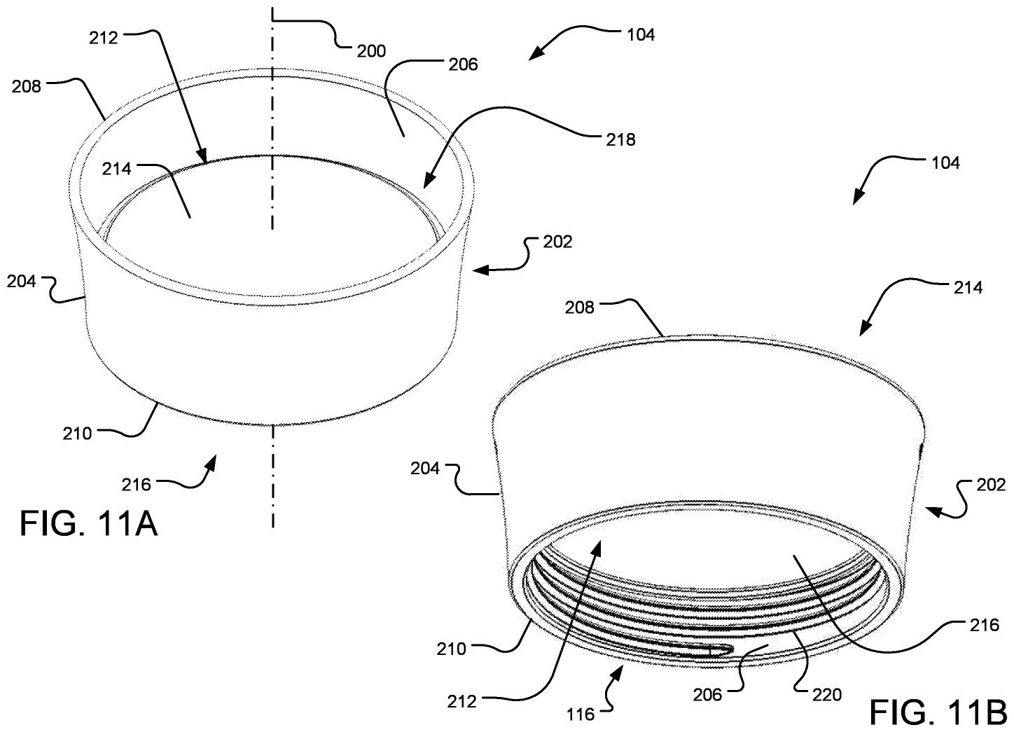

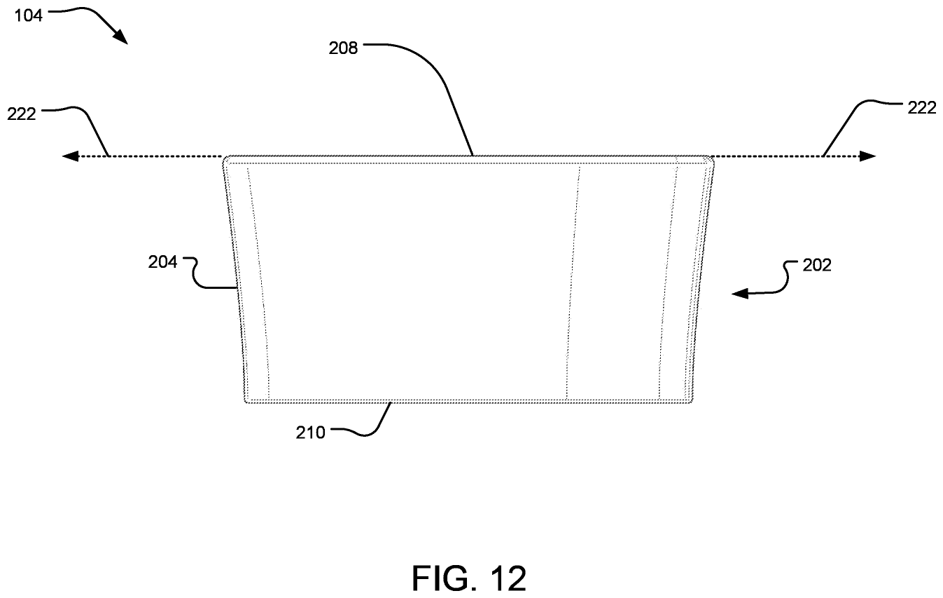

Turning to FIGS. 11A-12, in one implementation, the hanger assembly 104 includes an ant moat having a body 202 forming a vessel extending between a proximal edge 208 and a distal edge 210. The proximal edge 208 extends around a central line 200 and defines a plane 222.

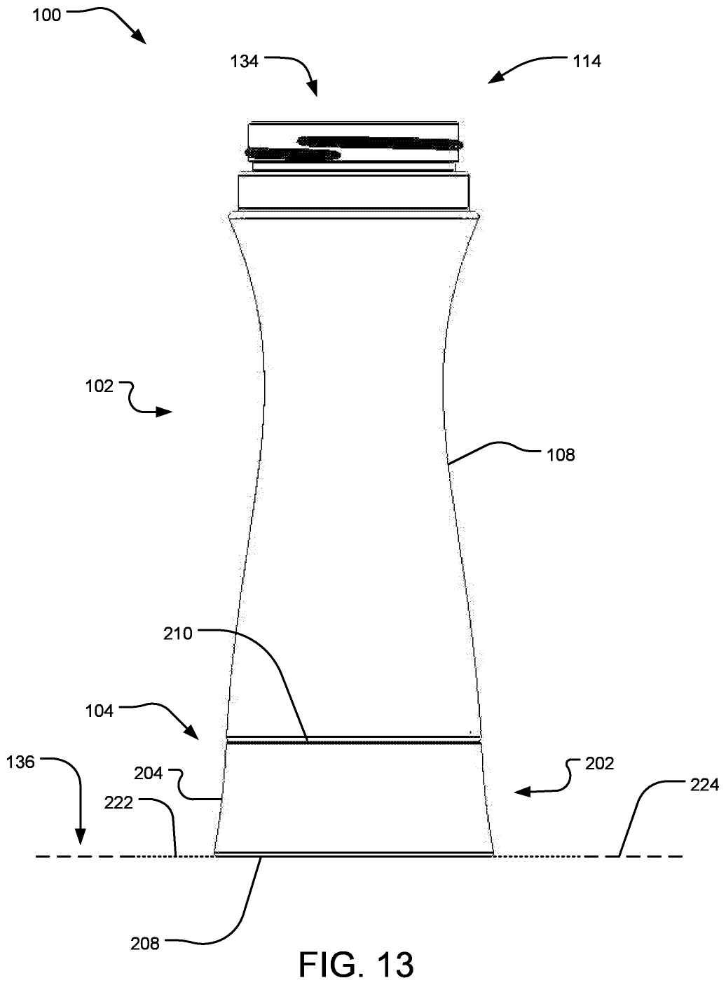

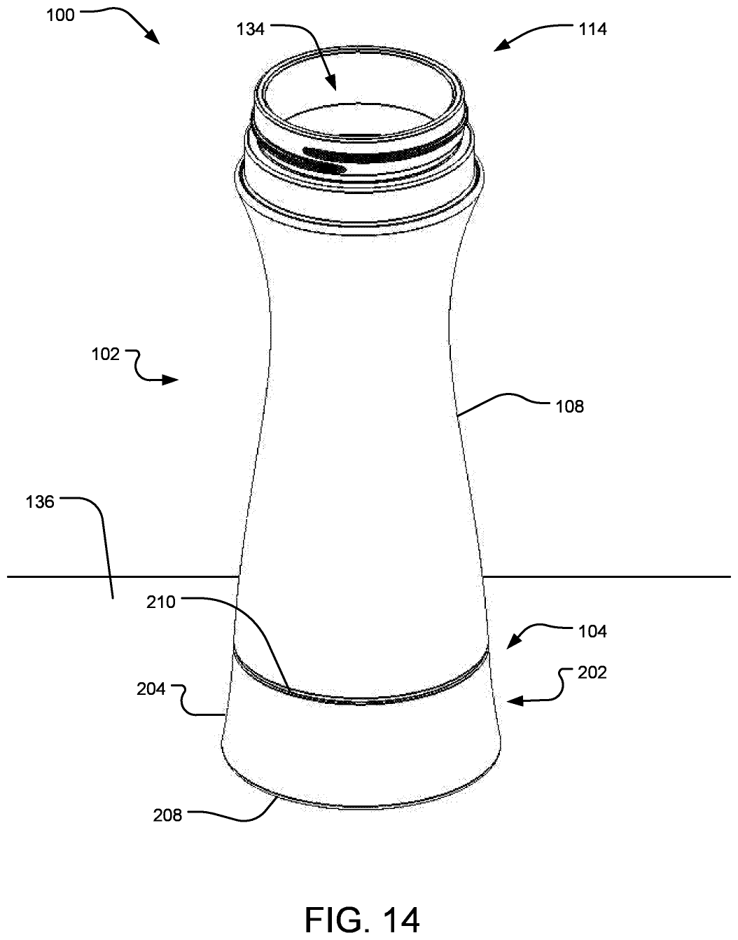

In one implementation, the body 202 includes an outer surface 204 and an inner surface 206 each extending distally from the proximal edge 208 and connected to each other by the proximal edge 208. The outer surface 204 and the inner surface 206 may be sized and shaped to match the size and shape of the reservoir 102. For example, as shown in FIGS. 13 and 14, the surfaces 204 and 206 match the shape of the elongated portion 108 of the reservoir 102 to create the aesthetic impression of a continuous shape.

The reservoir engaging portion 116 of the hanger assembly 104, as shown in FIGS. 11A-12, includes one or more engagers 220 disposed on the inner surface 206 and configured to engage the connecting portion 110 of the reservoir 102. In one implementation, the engagers 220 are helical threads. However, other types of engagers are contemplated, including without limitation, a lip, a protrusion, a surface configured for a snap fit, and/or the like.

In one implementation, the hanger assembly 104 includes a moat portion 212 connected to the body 202 within the vessel, such that the moat portion 212 extends from the inner surface 206. The moat portion 212 includes a proximal surface 214 and a distal surface 216. The proximal surface 214 is configured to receive and hold a fluid, such as water, through an opening 218 formed by the proximal edge 208, to capture ants or other pests trying to obtain the nectar, and the distal surface 216 is configured to receive the planar surface 112 of the reservoir 102.

As can be understood from FIGS. 13 and 14, in one implementation, to fill the nectar bird feeder 100 to feed one or more birds, the nectar bird feeder 100 is inverted and the basin assembly 106 is removed. Inverting the nectar bird feeder 100 before removing the basin assembly 106 reduces spillage of any nectar held in the reservoir 102 and/or the basin assembly 106. The hanger 122 (not shown) is pivoted, slid, or otherwise moved into the folded position, and the proximal edge 208 of the body 202 is placed on the surface 136. Stated differently, the hanger assembly 104 is configured to permit the plane 222 defined by the proximal edge 208 to substantially merge with a plane 224 positioned on the surface 136 when the proximal edge 208 meets the surface 136. Nectar is then poured into the reservoir 102 through the opening 134, which is sized to accept the nectar with minimum spillage. Still in the inverted position, the basin assembly 106 is secured onto the mouth 114. The nectar bird feeder 100 may be flipped over and the hanger 122 (not shown) pivoted into the upright position for hanging. In this position, gravity forces the nectar to dispense from the reservoir 102 into the basin assembly 106 for access by one or more birds.

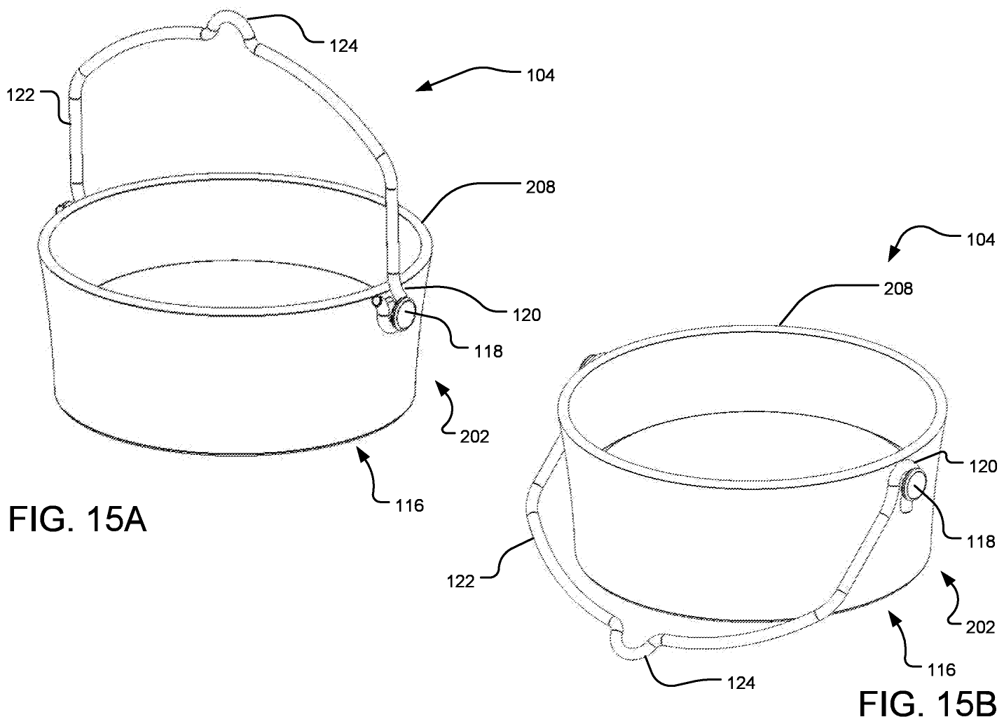

FIGS. 15A to 23B illustrate various examples of the hanger assembly 104 having an ant moat as described with respect to FIGS. 10-12. Such examples are illustrative only and not intended to be limiting. In each example, when in the folded position, no portion of the hanger assembly 104 intersects the plane 222 defined by the proximal edge 208 of the body 202, and each of the hanging portions 124 are positioned on or near the central line 200, such that the hanging portions 124 are at an approximate center of the vessel for stable hanging.

Turning first to FIGS. 15A and 15B, the second connector 120 of the hanger 122 is a hook adapted to engage the first connector 118, which is a peg protruding from the body 202 and disposed below the proximal edge 208. The first and second connectors 118 and 120 permit the hanger 122 to pivot to the folded position, such that the first and second connectors 118 and 120, the hanger 122 and the hanging portion 124 are all disposed distal to the proximal edge 208 and not intersecting the plane 222.

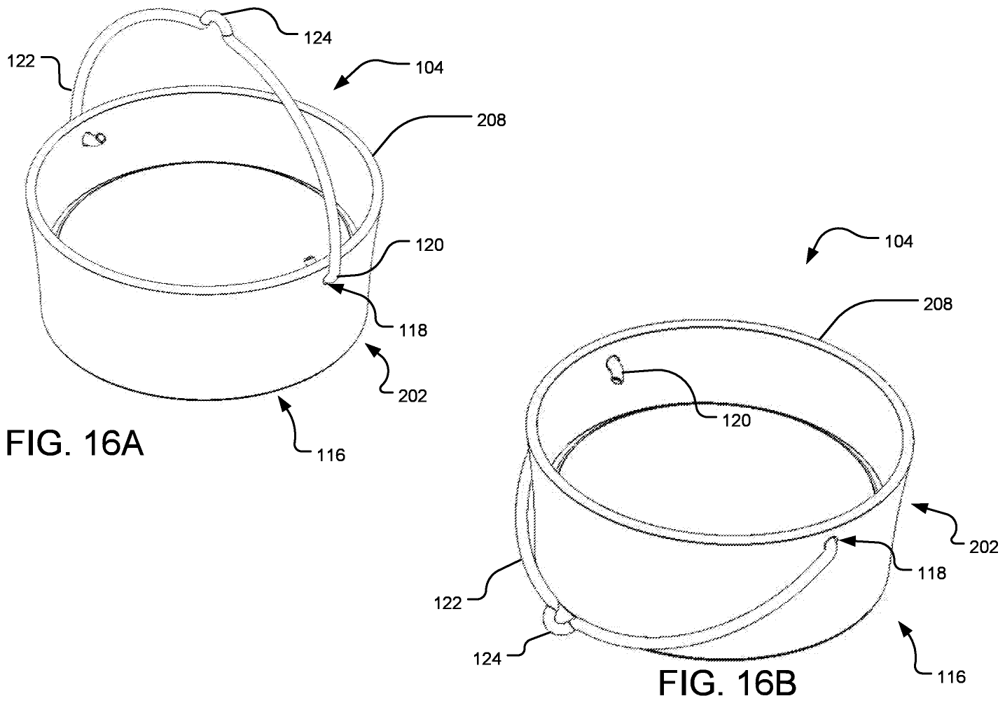

As shown in FIGS. 16A and 16B, the second connector 120 of the hanger 122 is a hook adapted to engage the first connector 118, which is a hole defined in and extending through the body 202 and disposed below the proximal edge 208. The hooks extend inwardly through the holes. The first and second connectors 118 and 120 permit the hanger 122 to pivot to the folded position, such that the first and second connectors 118 and 120, the hanger 122 and the hanging portion 124 are all disposed distal to the proximal edge 208 and not intersecting the plane 222.

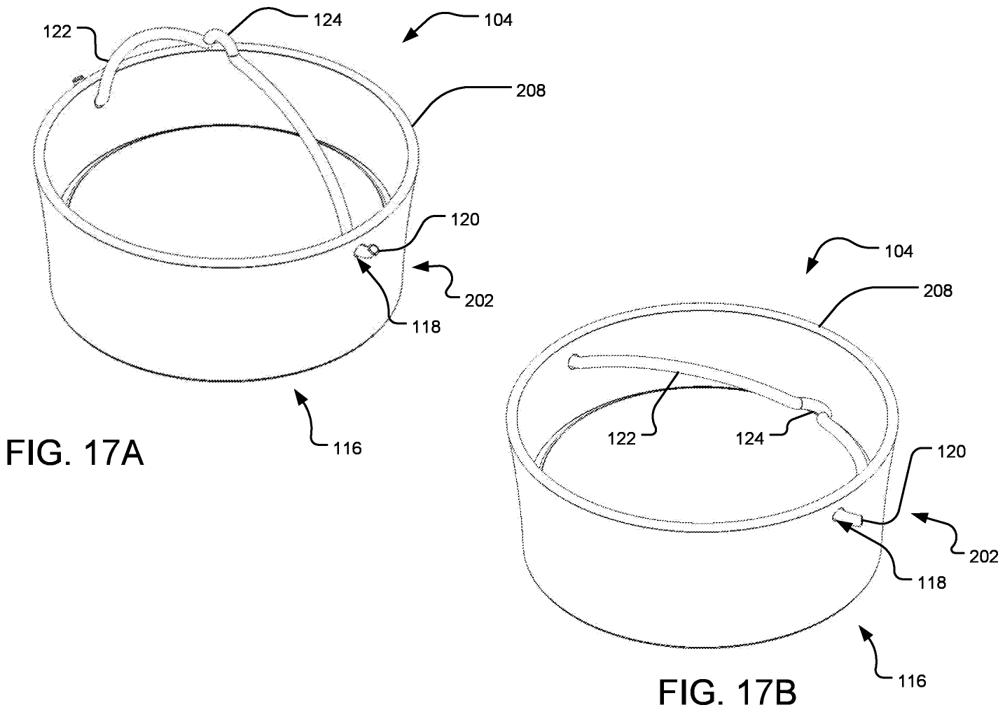

Referring to FIGS. 17A and 17B, the hanger 122 is disposed in the body 202, and the second connector 120 of the hanger 122 is a hook adapted to engage the first connector 118, which is a hole defined in and extending through the body 202 and disposed below the proximal edge 208. The hooks extend outwardly through the holes. The first and second connectors 118 and 120 permit the hanger 122 to pivot to the folded position towards the moat portion 212, such that the first and second connectors 118 and 120, the hanger 122 and the hanging portion 124 are all disposed distal to the proximal edge 208 and not intersecting the plane 222.

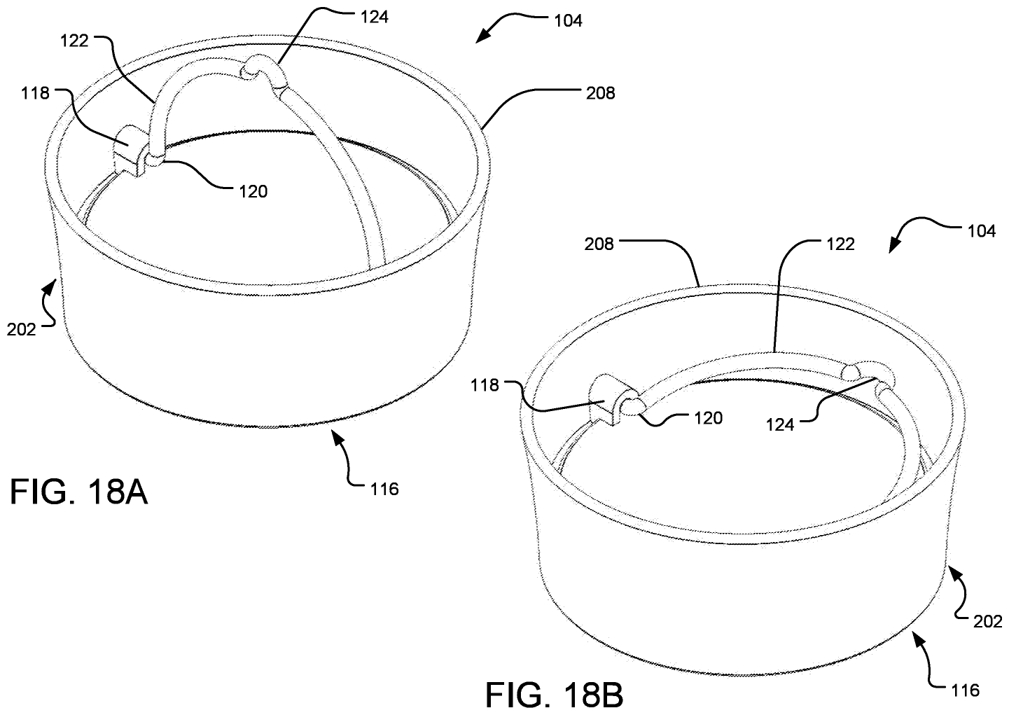

Now referring to FIGS. 18A and 18B, the hanger 122 is disposed in the body 202, and the second connector 120 of the hanger 122 is a hook adapted to engage the first connector 118, which is a slot positioned on the moat portion 212 at the body 202 and disposed below the proximal edge 208. The hooks extend outwardly into the slots. The first and second connectors 118 and 120 permit the hanger 122 to pivot to the folded position towards the moat portion 212, such that the first and second connectors 118 and 120, the hanger 122 and the hanging portion 124 are all disposed distal to the proximal edge 208 and not intersecting the plane 222.

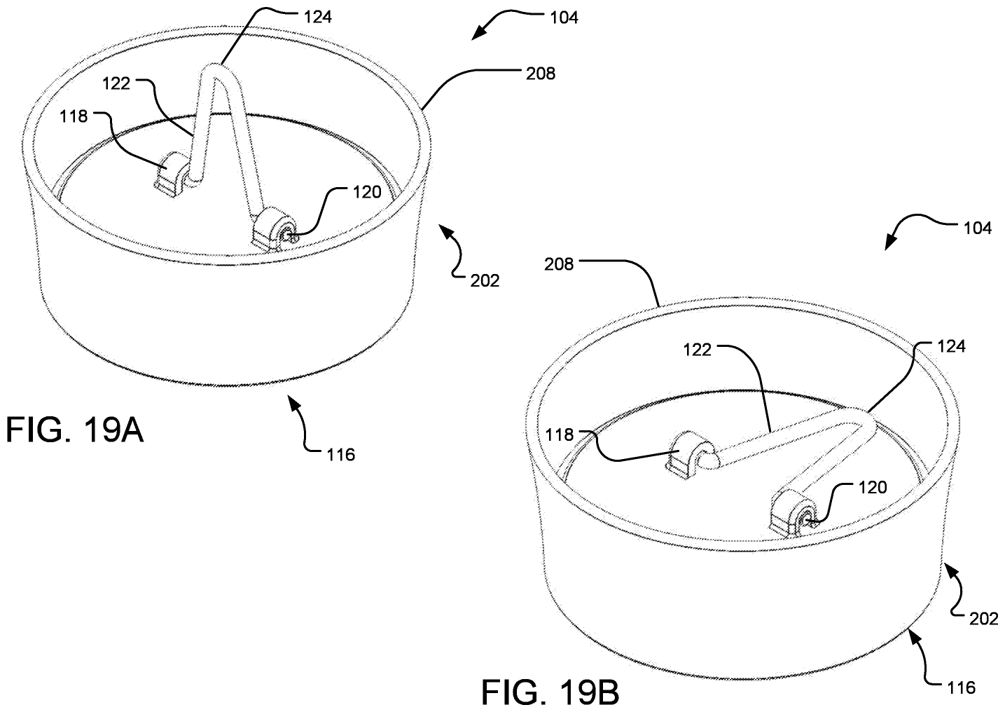

Similarly, as shown in FIGS. 19A and 19B, the hanger 122 is disposed in the body 202, and the second connector 120 of the hanger 122 is a hook adapted to engage the first connector 118, which is a slot positioned on the moat portion 212 and disposed below the proximal edge 208. The hooks extend outwardly into the slots. The first and second connectors 118 and 120 permit the hanger 122 to pivot to the folded position towards the moat portion 212, such that the first and second connectors 118 and 120, the hanger 122 and the hanging portion 124 are all disposed distal to the proximal edge 208 and not intersecting the plane 222.

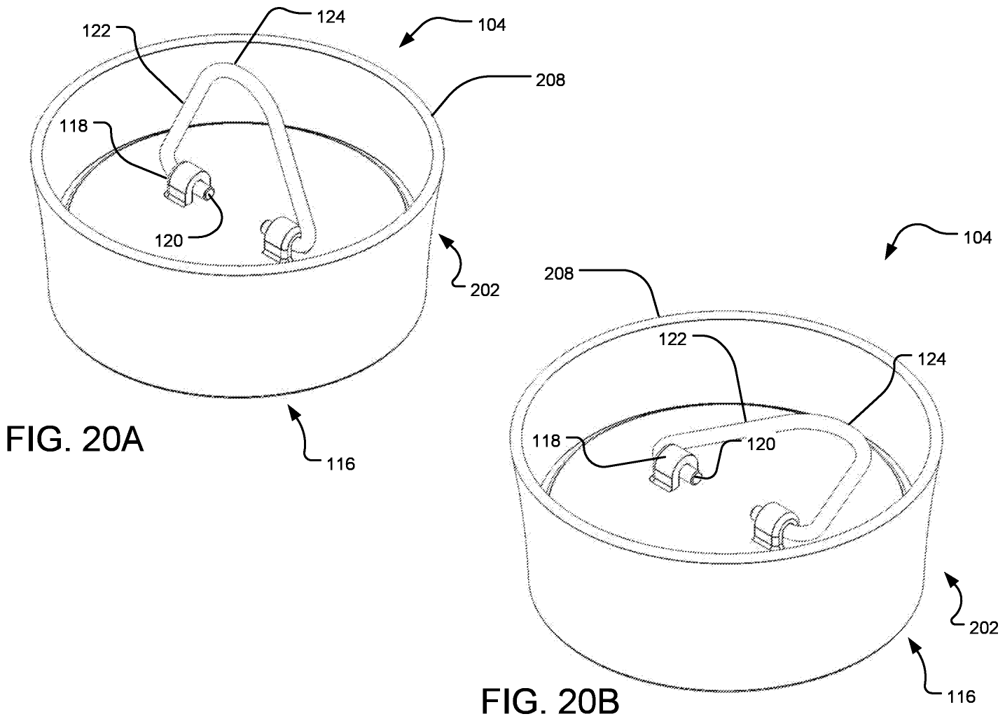

Turning to FIGS. 20A and 20B, the hanger 122 is disposed in the body 202, and the second connector 120 of the hanger 122 is a hook adapted to engage the first connector 118, which is a slot positioned on the moat portion 212 and disposed below the proximal edge 208. The hooks extend inwardly into the slots. The first and second connectors 118 and 120 permit the hanger 122 to pivot to the folded position towards the moat portion 212, such that the first and second connectors 118 and 120, the hanger 122 and the hanging portion 124 are all disposed distal to the proximal edge 208 and not intersecting the plane 222.

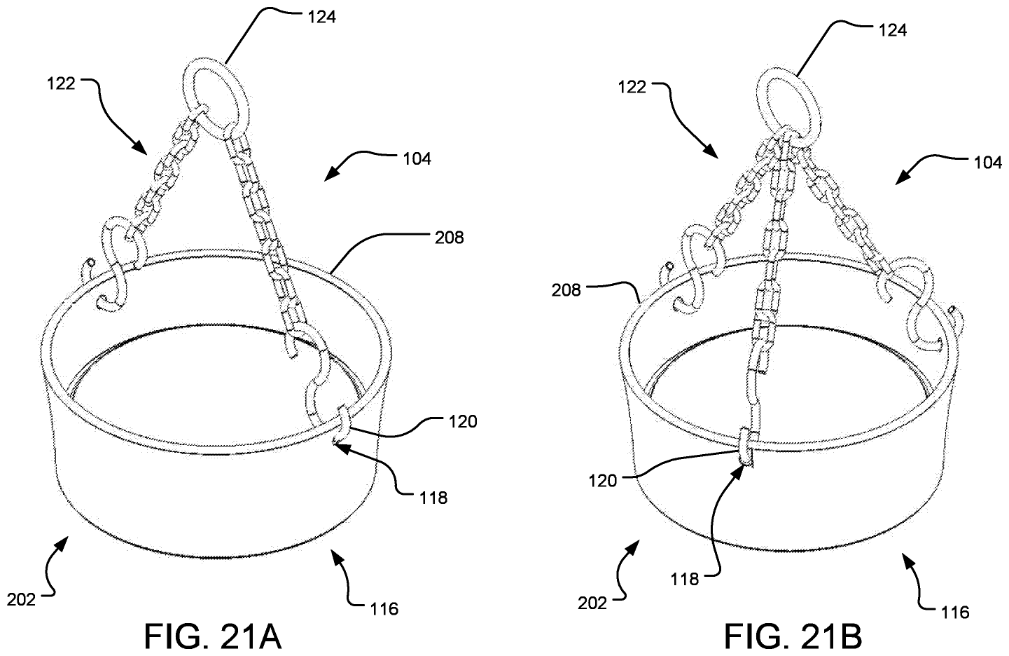

Referring to FIGS. 21A and 21B, the hanger 122 includes one or more chains, and the second connector 120 of the hanger 122 is a hook adapted to engage the first connector 118, which is a hole defined in and extending through the body 202 and disposed below the proximal edge 208. The hooks extend outwardly through the holes. The first and second connectors 118 and 120 permit the hanger 122 to collapse into the folded position with the chains resting within the body 202, such that the first and second connectors 118 and 120, the hanger 122 and the hanging portion 124 are all disposed distal to the proximal edge 208 and not protruding through the plane 222.

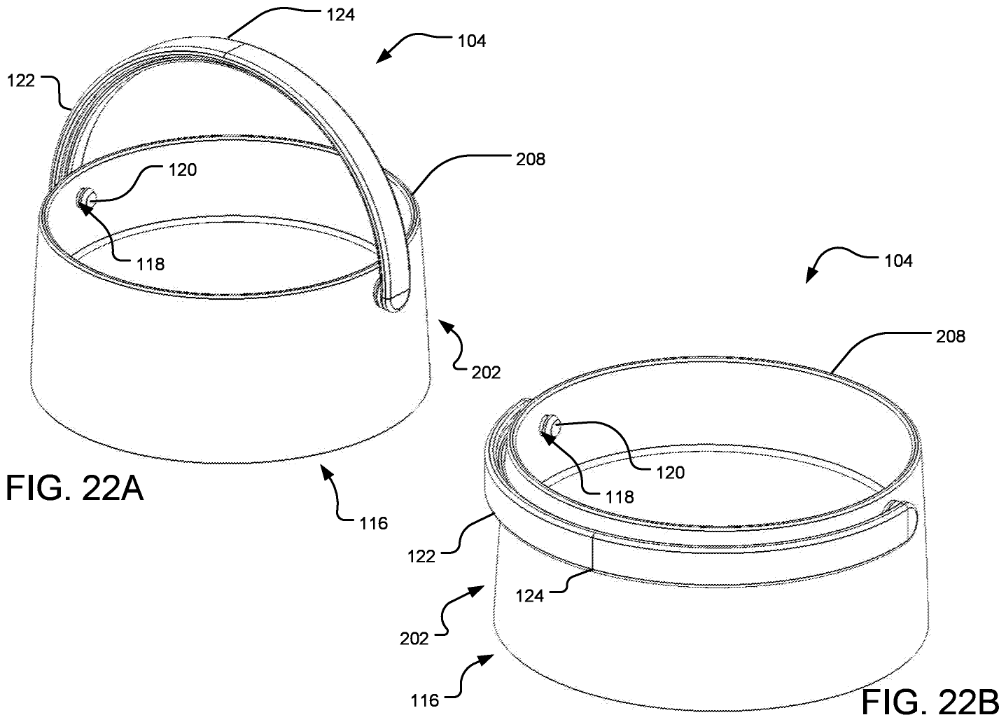

As shown in FIGS. 22A and 22B, the second connector 120 of the hanger 122 is a protrusion adapted to engage the first connector 118, which is a hole defined in and extending through the body 202 and disposed below the proximal edge 208. The protrusions extend inwardly through the holes. The first and second connectors 118 and 120 permit the hanger 122 to pivot to the folded position, such that the first and second connectors 118 and 120, the hanger 122 and the hanging portion 124 are all disposed distal to the proximal edge 208 and not intersecting the plane 222.

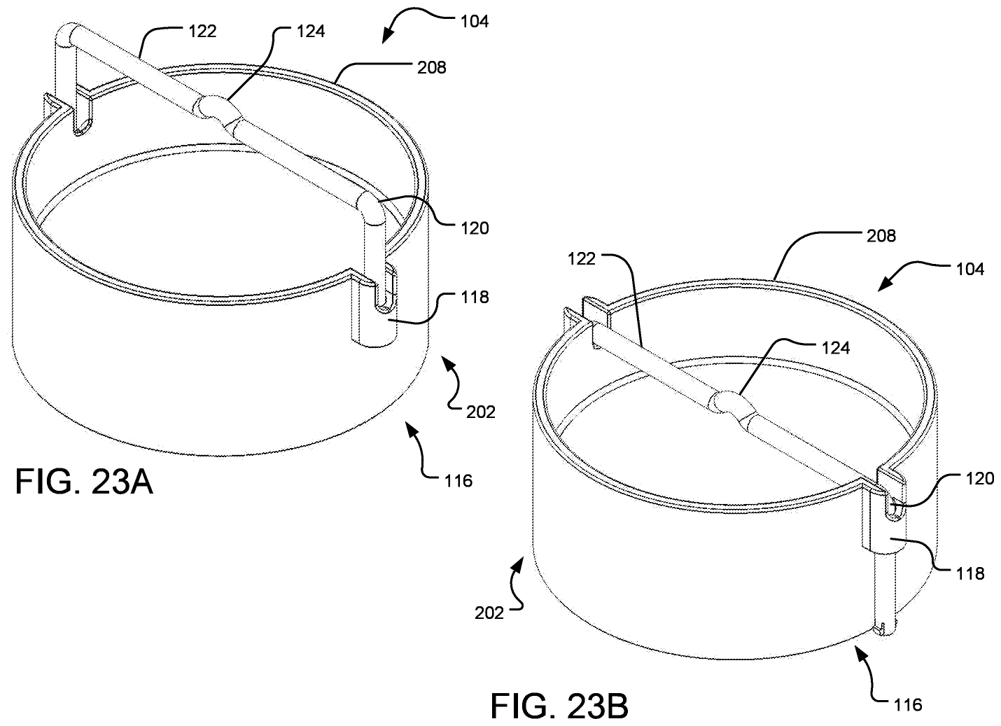

Turning to FIGS. 23A and 23B, the second connector 120 of the hanger 122 is an elongated portion adapted to engage the first connector 118, which is a slot positioned on the outer surface 206 of the body 202. The elongated portions slide vertically through the slots. The first and second connectors 118 and 120 permit the hanger 122 to slide distally to the folded position, such that the first and second connectors 118 and 120, the hanger 122 and the hanging portion 124 are all disposed relative to the proximal edge 208 to not protrude past the plane 222.

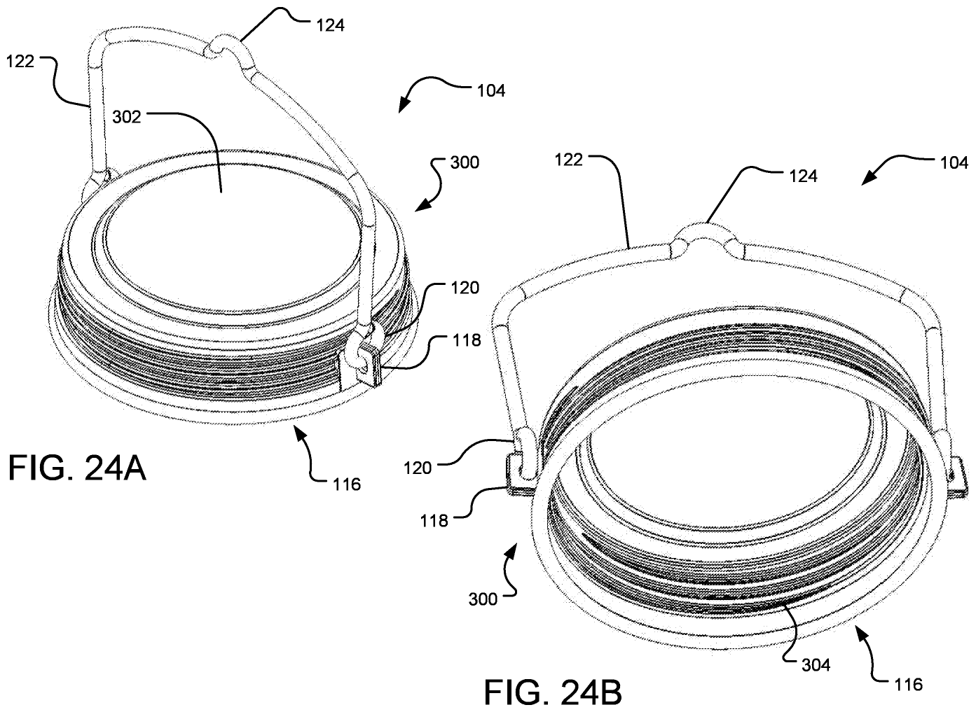

As can be understood from FIGS. 24A and 24B, in one implementation, the hanger assembly 104 may include a cap 300 having a planar surface 302 for positioning on the surface 136 when the nectar bird feeder 100 is inverted. The reservoir engaging portion 116 may have engagers in the form of helical threads 304 or other engages as described herein. The hanger assembly 104 may be made from a variety of materials, including but not limited to metal, glass, ceramics, plastics, or the like, and include one or more decorative features. To increase aesthetic appeal, the hanger assembly 104 may be made from a metal having decorative features, such as color (e.g., pewter), engravings, designs, or the like.

The cap 300 may be sized and shaped to mirror the size and shape of the connecting portion 110 of the reservoir 102, and the hanger 122 may be sized and shaped to adequately hold the seed bird feeder when suspended. In one implementation, the cap 300 includes the first connector 118 adapted to the second connector 120 of the hanger 122. The first and second connectors 118 and 120 may be any engaging feature that permits the cap 300 to attach to the hanger 122 in a manner that allows the hanger 122 to move between the upright and folded positions. For example, first and second connectors 118 and 120 may each be hooks having openings to engage one another in a manner that permits movement of the hanger 122. In one implementation, the hanger 122 includes the hanging portion 124 that permits the hanger 122 to securely attach to an item, such as a tree limb, hook, or the like.

Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The above specification, examples, and data provide a complete description of the structure and use of example implementations of the invention. Various modifications and additions can be made to the exemplary implementations discussed without departing from the spirit and scope of the presently disclosed technology. For example, while the implementations described above refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

What is claimed is:

1. A bird feeder comprising:
a body forming a vessel extending from a distal edge to a proximal edge;
a moat portion connected to the body and positioned within the vessel;
an opening formed by the proximal edge, the vessel configured to receive fluid through the opening; and
a hanger having a hanging portion positioned at an approximate center of the vessel, the hanger configured to move to a folded position distal to the proximal edge such that no portion of the hanger protrudes through the opening.

2. The bird feeder of claim 1, wherein the hanger moves to the folded position by sliding.

3. The bird feeder of claim 1, wherein the hanger moves to the folded position by pivoting.

4. The bird feeder of claim 1, wherein the body includes a reservoir engaging portion configured to engage a connecting portion of a reservoir.

5. The bird feeder of claim 4, wherein the reservoir engaging portion and the connecting portion each include helical threads to engage the body and the reservoir.

6. The bird feeder of claim 1, wherein the body is generally cylindrical in shape.

7. The bird feeder of claim 1, wherein the moat portion is generally planar.

8. A bird feeder comprising:
a proximal edge extending around a central line and defining a plane;
an outer surface extending distally from the plane;
an inner surface connected to the outer surface by the proximal edge, the inner surface extending distally from the plane;
a moat portion extending circumferentially from the central line to the inner surface;
an opening formed by the proximal edge and positioned on the plane; and
a hanger disposed distal to and not intersecting the plane, the hanger having a hanging portion positioned on the central line.

9. The bird feeder of claim 8, wherein the proximal edge extends generally circular around the central line.

10. The bird feeder of claim 8, wherein the outer surface is generally smooth.

11. The bird feeder of claim 8, wherein the inner surface includes one or more engaging features configured to engage a proximal end of a reservoir.

12. The bird feeder of claim 8, wherein the inner surface extends distally from the plane to the moat portion.

13. A bird feeder comprising:
a body extending around a moat portion, the body configured to receive and contain fluid on the moat portion;
an opening formed by an edge of the body and positioned on a first plane, the edge configured to meet a flat surface positioned on a second plane; and
a hanger having a hanging portion, the hanger configured to permit the first plane to substantially merge with the second plane when the edge meets the flat surface.

14. The bird feeder of claim 13, wherein the hanging portion is positioned relative to an approximate center of the first plane.

15. The bird feeder of claim 13, wherein the hanger extends proximally from the moat portion.

16. The bird feeder of claim 13, wherein the hanger is disposed distal to and not intersecting the first plane.
